(19) United States
(12) Patent Application Publication
(10) Pub. No.: US 2002/0052708 A1
(43) Pub. Date: May 2, 2002

(54) Optimal image capture

(76) Inventors: Stephen B. Pollard, Gloucestershire (GB); Stephen Philip Cheatle, Bristol (GB)

Correspondence Address: HEWLETT-PACKARD COMPANY, Intellectual Property Administration, P.O. Box 272400, Fort Collins, CO, 80527-2400, US

(21) Appl. No.: 09/955,141

(22) Filed: Sep. 19, 2001

(30) Foreign Application Priority Data
Oct. 26, 2000 (GB) 0026198.2

(51) Int. Cl. G01C 9/00; G06F 15/00; G01C 17/00; G01C 19/00

(52) U.S. Cl. 702/151

(57) ABSTRACT

Target viewing apparatus comprises a plurality of spaced electronic viewing cameras 15-18 for viewing a predetermined region 5 and for providing respective image signals, the field of view of at least two viewing cameras overlapping in at least a part of said region, identification means for identifying or detecting a target object within said part of said region, and control means (FIG. 6) responsive to said identifying means for selecting an image signal from a selected one of said at least two cameras, wherein said control means includes means for assessing the pose (attitude) of the target and selection means arranged for selecting the said one camera at least partly upon the assessed pose. The selected camera may be the one seeing a pose nearest to a predetermined pose, or to a pose determined by other parameters associated with the target and/or other parts of the region 5 whether or not determined in conjunction with a predetermined pose.

### FIELD OF THE INVENTION

The present invention relates to the control of multiple electronic camera systems.

### BACKGROUND OF THE INVENTION

When it is necessary to view an area or volume (a region) which is extended or which contains obstructions, it is frequently necessary to provide a plurality of cameras at spaced locations which between them are capable of covering more of the region that any single camera alone. Examples of such regions are a bank or other place where security is a prime consideration; a public area such as a street or railway platform where it may be necessary to observe a crowd of people for safety reasons, or as an aid to detecting criminal activities; shops where shoplifting is becoming increasingly prevalent; and roads for traffic surveillance.

It is also often desirable to obtain a better view of a target object, or an event, than can always be provided by a single camera at a fixed location. For example a plurality of cameras at fixed spaced locations may be provided at a sporting event so that a more detailed picture of the action may be obtained wherever it occurs, and/or so that the action may be viewed from a good camera angle.

In either case, it is common for an operator to be provided with a bank of monitors showing the pictures coming from each camera. The bank of monitors may or may not be remote from the viewed region. The operator will frequently have the facility to display the picture from any selected camera in greater detail on a primary monitor. Any or all of the plurality of cameras may be adjustable for direction (pan and/or tilt) and/or field of view (focal length or zoom), and the operator may be able to vary these settings on the selected camera while viewing the primary monitor.

If factors such as cost, complexity and/or bandwidth limitations become significant, the size of the monitor bank may be reduced to show pictures from a selection of the cameras. This selection may vary with time so that ultimately pictures from all cameras are seen. When a picture signal from one camera is substituted by that from another camera, this is known as camera handoff.

Circumstances arise where it is not possible or practical to transmit or record the signals from each camera, for example because of bandwidth limitations on the transmission path, or because it would be require an excessive provision for recording. Furthermore, if power is limited, only one or a reduced number of the cameras may be active at any time. In such circumstances, it is necessary to determine which of the picture signals are to be transmitted and/or recorded (and if appropriate which cameras are active), and it is possible that only one picture signal, for example that providing the picture viewed on the primary monitor, is recorded and/or transmitted.

In multiple camera systems where it is desired to view a moving target object, the decision may be based upon detection of the position of the target relative to the cameras. Once detected, the target may be automatically tracked with camera handoff as appropriate.

A number of ways are known in the art for detecting a target, for ascertaining its position, and/or for correlating the target position to the camera positions or fields of view. See, for example, M Bichsel, “Segmenting Simply Connected Moving Objects in a Static Scene”, IEEE Trans PAMI, 16:1138-1142, 1994.

It is known to provide image processing algorithms for identification of a target object in a camera's field of view. An exemplary disclosure is found in G Sullivan, “Model-Based Vision for Traffic Scenes Using the Ground Plane Constraint”, Real time Computer Vision”, Ed C M Brown & D Terzopoulos, 93-115, Cambridge University Press, 1994. These may respond, for example, to an extrinsic property of the target such as movement, or to an intrinsic property such as hue or colour, pattern, texture or shape (as two-dimensional outline in the viewed picture derived from what is normally a three dimensional object), or to any linear or non-linear combination of these, with appropriate weighting if deemed necessary. The response may occur only in response to values of such properties within predetermined ranges. Where the target is rigid, the relation between the outline and the shape is relatively simple. Where the target is flexible and may change shape, such as a human body, algorithms exist for modelling possible shapes and matching one of them to a target in the viewed picture when present, see for example:

G Edwards, C J Taylor & T F Cootes, “Interpreting Face Images Using Active Appearance Models”, 3rd International Conference on Automatic Face & Gesture Recognition”, 300-305, Japan, 1998; and

D C Hog, “A Program to See a Walking Person”, Image and Vision Computing, 1(1), 5-20, 1983.

An additional known technique is to provide an alarm sensor, e.g. a pressure mat or vibration sensor, within one or more fields of view. Triggering of the sensor by a target may cause the corresponding camera(s) to be activated, if asleep, and for a target identification/location to commence in the pictures provided by these cameras.

Another known option is to provide for selection of a target by the operator, for example by the technique known as “outlining”, subsequent to which operation the target and its position may continue to be identified as it moves. The use of a standard mouse for this purpose is typical of many computer programs for image manipulation. It can involve a number of mouse clicks and drags to draw a line that follows a fairly precise outline of the object to be tracked. Where it is not possible to outline a quickly moving target, the image is either frozen or a less precise outline is marked, e.g. a roughly bounding box or ellipse. In the limit the outlining could be reduced to clicking the mouse within the viewed target object so that thereafter the system automatically identifies the actual outline of the object to track.

It is also known to track a target as it moves out of view of one camera and into the view of another camera. Depending on how the camera installation is arranged, adjacent fields of view provided by different cameras may abut, overlap or be spaced.

Where the fields of view overlap or abut, analysis of the target location in the existing picture allows-easy determination of the next camera for handoff, for example by using a map of the viewed region containing information about the field of view of each camera and its location relative to the entire region. If appropriate the map could be adaptively adjusted to take into account the existing pan/tilt/zoom settings of each camera. Where the fields are spaced there will be uncertainty as to which camera to use next, but an indication can be derived by using a map and the movement of the target in the picture from the existing camera to predict which camera or cameras (including the existing camera) are most likely to see the target next. Where a camera (or cameras) which is expected next to view the target is adjustable, its pan and tilt settings may be controlled to increase the probability of intercepting the target, and it may be zoomed out to the maximum setting for the same reason.

A target tracking system is described in International Patent Application No. PCT/EP99/05505 (Koninkluke Philips Electronics N.V.) for use for example in a security system or a multi-camera broadcasting system. A target is selected, its location is determined, and its movement is tracked between cameras, with corresponding control of camera handoff. One way of determining the direction of the target relative to the camera position is to realign the camera until the target is at the centre of the field of view, and to measure the camera attitude. Alternatively, with a fixed camera, the distance of the target from the centre of the field can be measured. The distance of the target from the camera may be determined by triangulation methods, or by providing a signal from an autofocus mechanism of the camera. From the direction and distance, and the map of the region, the position of the target within the region can be determined.

In this system at least two cameras have overlapping fields of view, and the question then arises as to where camera handoff will occur within the overlapped fields. This could be done on the basis of the first selected camera remaining such until it loses sight of the target, or until the target is approaching the edge of its field, or on selection of a new camera whenever the target enters its field. Another option is to select the camera which is judged to be nearest to the target. Weighting of a number of factors to do with anticipated target position can be used to determine which camera to use.

However, there are situations under which the best view, i.e. that which would be selected by a human operator for a certain purpose, has no direct relation with target position. For example, if the target is a person and it is required to provide identification from a face view, it is no good using the nearest camera if the target is facing away therefrom; if it is desired to view a pickpocket or shoplifter at work, it is no good having a good view lacking detail of the hands; and if vehicle number plate identification is required, a sideways view is of no utility.

Accordingly, the present invention seeks to identify and take account of the pose, i.e. the spatial orientation or attitude of the object within the region.

### SUMMARY OF THE INVENTION

In a first aspect the invention provides target viewing apparatus comprising a plurality of spaced electronic viewing cameras for viewing a predetermined region and for providing respective image signals, the field of view of at least two viewing cameras overlapping in at least a part of said region, identification means for identifying or detecting a target object within said part of said region, and control means responsive to said identifying means for selecting an image signal from a selected one of said at least two viewing cameras, wherein said control means includes means for assessing the pose of the target and selection means arranged for selecting an output image signal from the said one viewing camera at least partly upon the assessed pose.

In a second aspect, the invention provides a method of controlling a plurality of spaced viewing cameras each viewing the same target object, the method comprising assessing the pose of the target and selecting an output image signal from one of said viewing cameras at least partly on the basis of the assessed pose.

As indicated above, identification and tracking of a target is well known in the prior art. In practising the invention, more than one such way of target identification may be used, and the method employed may vary with time or other circumstances. Thus information concerning the target may be collected and analysed over a period of time to enable subsequent identification thereof.

For example, while a target may initially be detected by means of a characteristic velocity, analysis of its image as it moves may enable a three-dimensional model thereof to be built up, so that subsequent identification may proceed on the basis thereof, either per se or in addition to velocity or other information.

Similarly, while a target may initially be identified by a human operator, characteristics of its image, such as texture and shape, but also including motion, may thereafter be analysed to provide further information for subsequent target identification and location.

Tracking of the target outside the overlapped fields will normally be accompanied by camera handoff as required. The control means may be arranged in any of a number of ways for camera control, provided that the camera providing the selected image signal is active. For example (a) all viewing cameras may be active where power is not a limiting factor; (b) only the viewing camera or cameras actually viewing the target may be active, with or without the viewing camera to which the next handoff is predicted to occur; or (c) only the viewing camera providing the selected image signal may be active, with or without the viewing camera to which the next handoff is predicted to occur.

In a further variation, a master camera, which is not one of the viewing cameras, is provided which is permanently active and views substantially all of the region. Its signal may be used in tracking the target and/or in pose assessment. One of the viewing cameras could be used in like manner.

Correspondingly, camera handoff will involve selection of signals from at least two active viewing cameras, or selective activation of viewing cameras as appropriate. In whatever way the plurality of cameras is controlled, in the present invention once the target is inside the overlapping fields, camera handoff, whether it involves image signal selection from active viewing cameras, or activation of a selected viewing camera, will also be subject at least in part to pose assessment.

There are three degrees of freedom associated with the location of a rigid object, and three associated with attitude. According to the intended application determination of the location and pose presented by a target to a camera could require an assessment of all six degrees of freedom. However, it will be appreciated that the application may well preclude variations in some of these degrees of freedom. For example, many target objects (e.g. vehicles, pedestrians) will stay on the ground in an upright or generally upright position.

Pose assessment may be by measurement or inference, or a combination of both. One way of effecting such a combination would be to use a predetermined algorithm to assign a weighting to each measurement according, for example, to the likelihood of the individual assessment being accurate, and then to combine the measurements in some predetermined manner.

The manner of assessment may also change with time as more is learnt about the target and/or its behaviour.

From the assessment may be obtained a vector relating the pose to a reference set of directions. By using a map of the region which includes data relating to the camera positions, their instantaneous fields of view, and by feeding in the target position and the assessed pose/vector, it is possible to determine not only which other cameras can see the target (or would do if appropriately controlled as to pan/tilt/zoom), but also what pose the target presents thereto.

One way of providing an assessment of pose is by analysis or measurement of the signal as provided by one or more cameras. This may involve measurement of one or more parameters associated with the target or target image, indicative of intrinsic or extrinsic target properties. It may involve parameters not directly associated with the target. When the target is only visible to one camera, this will be the one providing the signal for analysis. When the target is instantaneously visible to more than one camera the signals from more than one such camera could be used conjointly in assessing pose, or a signal from one of such cameras could be used, e.g. that instantaneously providing the image signal selected by the control means, or a predetermined one of the cameras. As mentioned above, the signal from a master camera could also be used for this purpose. The camera in use for pose measurement will be referred to as the pose measuring camera.

Where the object is flexible, the modelling referred to earlier can be used to provide a version of the object which version can then be treated as a rigid object for the assessment of pose

Typical methods of pose measurement from an image are:

(a) Measurement of the absolute or relative amount (area) of flesh tone to indicate where a human target is looking relative to the pose measuring camera. This will commonly also involve a measurement of the distance between the target and the pose measuring camera. This method can be regarded as a measurement of pose of a target head, or an inference of whole body pose (see below).

(b) Use of a rigid modelling technique to provide a match between the two-dimensional detected target shape in the image and a predetermined three-dimensional target shape, thereby to indicate the pose presented to the pose measuring camera. If only relative values such as the ratios of lengths are required, the distance between the target and the pose measuring camera may not be required. This technique may also be used where the target bears a known pattern on its surface.

(c) Use of a flexible modelling technique to provide a match between the two-dimensional detected target shape in the image and a three-dimensional flexible target shape, thereby to obtain an indication as to the rigid three-dimensional shape instantaneously adopted by the target, and an indication of the pose presented to the pose measuring camera by that instantaneous shape. The derivation of the pose may thereafter be performed as in (b) above.

All of (a) to (c) involve measurements based on an intrinsic target property, such as area of a predetermined hue or shape, and involve a visible characteristic of the target itself.

Pose assessment by inference may involve determination of characteristics pertaining to the target or other parts of the viewed scene.

Typical examples are:

(i) Target velocity. If the target is human, and is moving, it is likely that they are bodily and facially directed in the direction of movement, the more so the faster the movement;

(ii) If the target is human, and the pose of the head has been determined (see (a) above), the pose of the body may be inferred by assuming that the head is facing forward. This may be more certain if the target is determined to be moving at more than a threshold speed.

(iii)Target location. If the target is determined to be at a certain place in the map where a particular function is expected to be performed. This determination could be linked with other variables. For example a human is determined to be at a bank counter or automatic telling machine (ATM), they are likely to be facing the counter or machine. This is more particularly so if the target is also determined to be substantially stationary.

(iv) If the scene is a football game, it may be desired to track and view a particular player who is identifiable, for example, by number and kit colour. However, it may simultaneously be possible to track the ball and the position thereof, and use that in conjunction with the detected position of the player to provide an assessed pose, e.g. as a function of the relative positions of the player and ball, according to a predetermined algorithm (which may take into account other factors such as the velocity or speed of the player).

(i) to (iv) involve parameters not intrinsic to the target, e.g. speed/location of the target, other non-target factors in the viewed region.

The selection means takes the assessed pose and makes a judgement as to which viewing camera is to provide the selected image signal. In so doing, it may merely select a camera to which the target is judged to present a pose nearest to a required pose.

The required pose may be a predetermined parameter, e.g. one entered on setting up the apparatus. A predetermined pose will be decided by the particular application of the apparatus. Thus, when facial identification is desired, the predetermined pose could be a straight head-on or rear view, a three-quarter view, or a profile (side) view. When it is desired to observe shoplifting, a sideways view may be preferred, particularly a view including the target's hands and the goods in question. For identification of the number plate and type of a vehicle a view somewhat offset from a head-on view may be required. Once the pose of the target is known, selection of the most suitable camera view can be performed by an algorithm on what are essentially geometrical grounds.

Alternatively the required pose may be a variable factor, for example being determined solely by one or more other parameters (target or otherwise) in the overlapping fields and/or elsewhere in the predetermined region, or being determined by a predetermined pose (as mentioned above) as modified by such parameter(s).

Parameters such as one or more of target speed/velocity, target location, and target environment, e.g. the presence/speed/location of other objects may be taken into account, and when more than one such factor is involved, weightings may be attached thereto in determining the required pose. Determination of a variable required pose may be a non-linear process and may sometimes be best effected using one or more look-up tables.

Thus wherever two or more objects interact, such as when surveying a scene where criminal activity is suspected to be taking place, or a football match, more than one target may be identified and tracked. In a football match, both the referee and a target player be identified, and the required pose of the target may be determined by their relative locations and/or movements.

Furthermore, the selection means may take additional factors into account in making the selection of image signal. For example, where two cameras are viewing the target, but from significantly different distances, distance may be a factor which eventually over-rides selection of the camera providing a pose closest to a predetermined pose. A similar consideration could apply to location in the fields of view of the two cameras. Or if an alarm is activated, this may over-ride the camera selection process to provide a predetermined view of the area where the alarm sensor is sited. Again, the selection means may additionally be arranged to analyse the signal from the viewing camera intended to be selected to ensure that the view of the target is not obstructed prior to actual selection thereof, or to ascertain the degree of obstruction thereof, and if there is (more than a predetermined degree of) obstruction to select an alternative camera or the one with the least obstructed view, for example.

Commonly the apparatus will be arranged to track the target, with associated camera handoff, as is known in the exemplified prior art. However, the reader will appreciate that camera handoff is now subject to an additional factor, that of pose, and it is possible that in at least some forms of apparatus according to the invention, including those where only one camera is active at any time, that camera handoff can be initiated by a change of pose of the target not involving any change in target location.

At least one of the plurality of cameras may be a digital photographic camera. If it, or another video camera, offers higher resolution than other cameras, this factor may be taken into account by suitable weighting in the camera selection process.

### BRIEF DESCRIPTION OF THE DRAWINGS

Further features of the invention will become apparent upon a reading of the appended claims to which the reader is referred, and upon consideration of the following description of an exemplary embodiment of the invention made with reference to the accompanying drawings in which:

FIG. 1 is a map of the region to be viewed, including camera positions.

FIGS. 2 to 5 show polygonal figures representing the fields of view available to each camera.

FIG. 6 is a schematic block diagram of control means for operating the cameras.

### DETAILED DESCRIPTION OF THE PREFERRED EMBODIMENTS

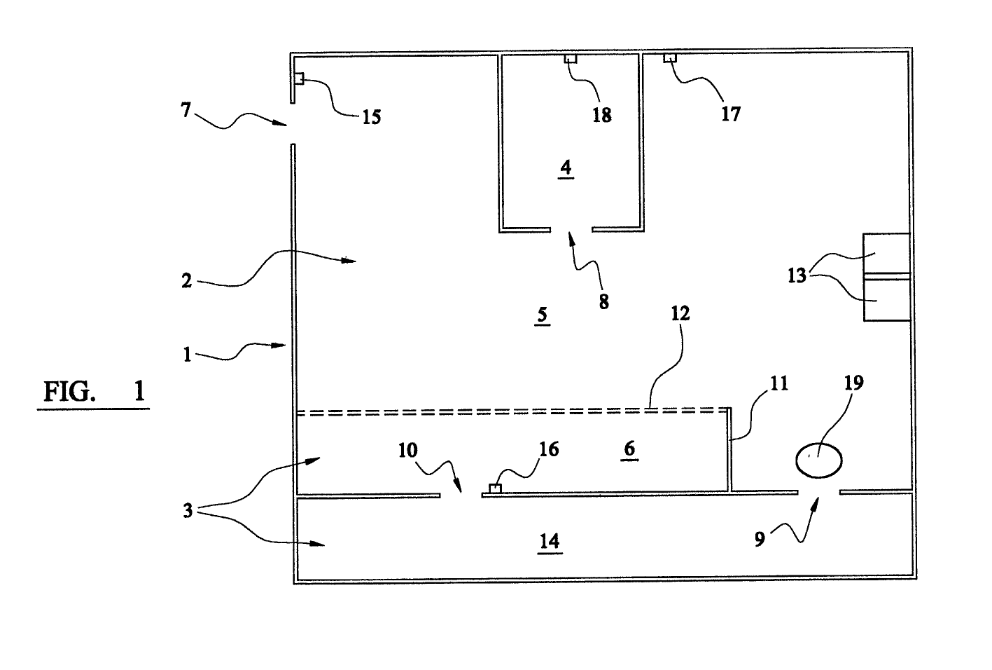

FIG. 1 shows a map of a part 1 of a floor of a building, including an area 2 to which the public is admitted, and an area 3 from which the public is normally barred. External access to the area 2 is via a doorway 7. The area 2 is subdivided into a room 4 having generally opaque walls and a doorway 8, and a large open area 5 which includes machines 13 (for example ATMs).

Area 3 is entered from the area 5 via a doorway 9 which is normally closed by a security door. It comprises a service counter 6, having a solid end wall 11 and a transparent wall 12, and a rear obscured area 14 containing the doorway 9 and a doorway 10 leading to the service counter 6. An alarm sensor such as a pressure mat is located in area 5 adjacent the doorway 9.

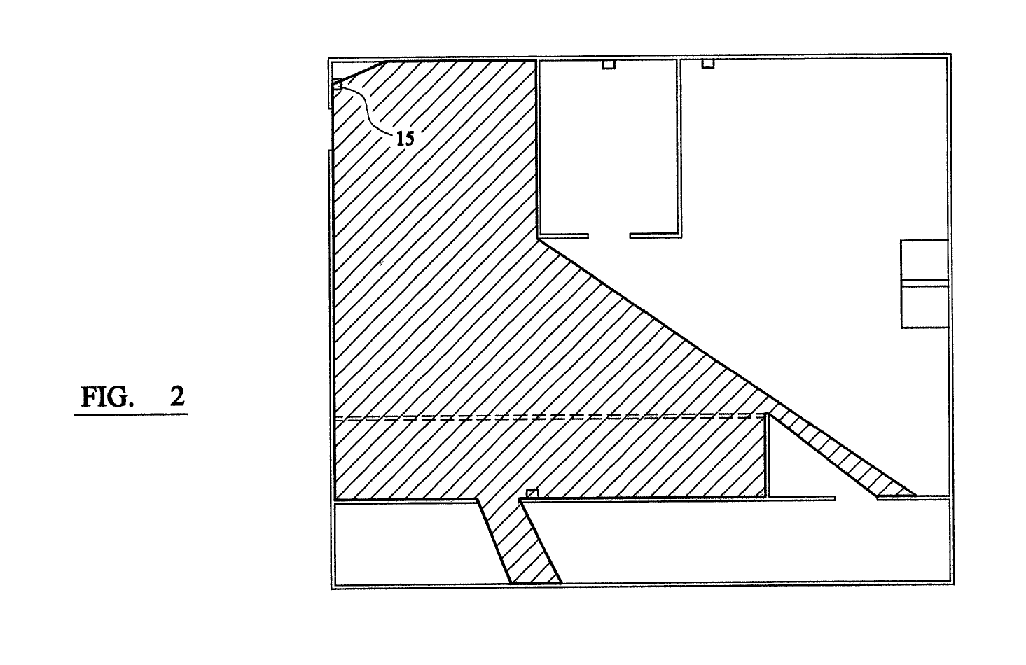

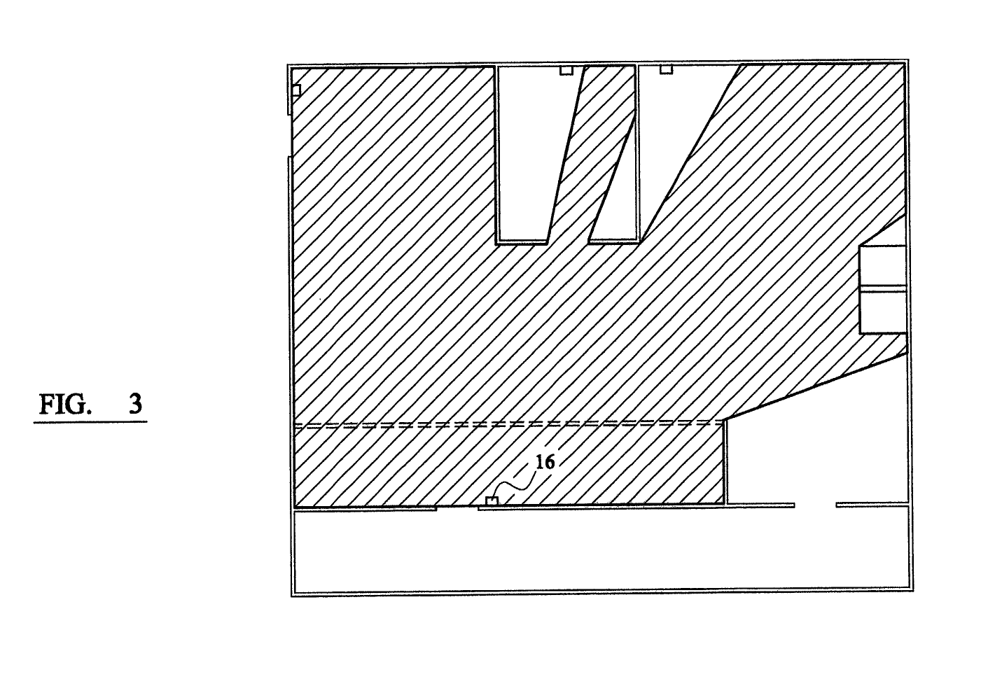

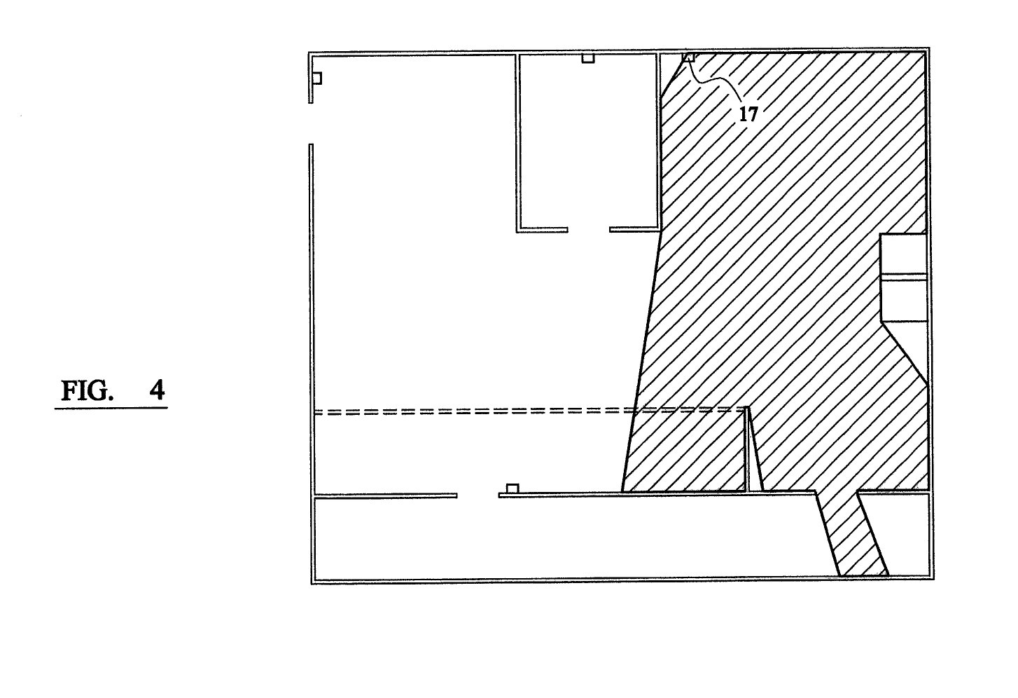

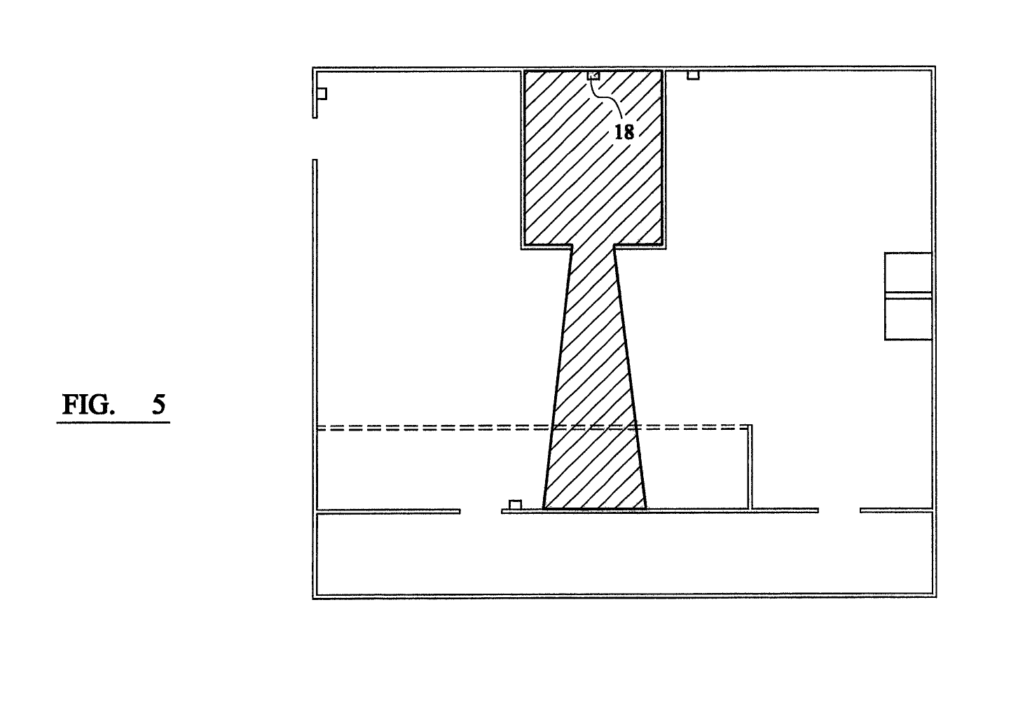

Three cameras 15 to 17 are mounted in area 2 and a further camera 18 is mounted in the room 4, and FIGS. 2 to 5 illustrate the maximum fields of view available to cameras 15 to 18 respectively.

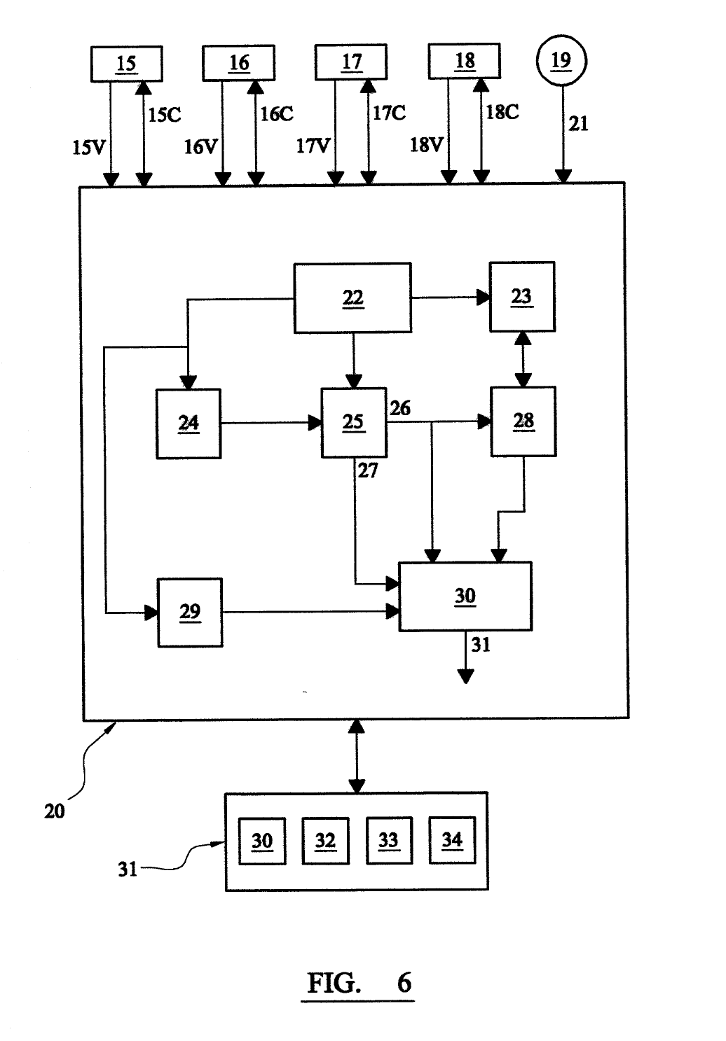

The control means 20 shown in FIG. 6 receive video signals from each of the cameras 15 to 18 over a channel 15V to 18V respectively, and is also coupled to each camera 15 to 18 over a bidirectional control channel 15C to 18C respectively. The output of the alarm sensor 19 is coupled to the means 20 via a cable 21. The control channels enable control of the pan, tilt and zoom of each camera via the means 20, with each camera providing to means 20 a measurement signal corresponding to the exact instantaneous setting of each camera relative to a reference state.

The control means acts upon the various inputs received to control which one of the video signals is selected e.g. for display on a local monitor 30 of a console 31 and/or recording.

Within the control means 20 is a database 22 incorporating the geographical details of the region 1, including the reference states and positions of each camera (the map), and from this is derived at view means 23 the instantaneous fields of view available to each camera. Also within control means 20 is a target detection means 24, which may be any means known in the art such as those discussed in the preamble of this specification. In one embodiment, all the video signals from cameras 15 to 18 are analysed locally in means 24, either simultaneously or sequentially, until a target is detected by its pattern or shape. The database 22 includes data for use in identifying the target and its pose according to predetermined criteria which are either set when establishing the system or are adjustable by the operator (for example when target identification is by “outlining”).

Once a target is detected by a particular camera, it is tracked in known manner by a tracking means 25 operative upon inputs including the map and the video signal from the particular camera in use to provide an indication of target position at an output 26 and target velocity at an output 27. Information concerning the target may be provided to tracking means 25 by the detection means 24.

The control means 20 also includes a pose assessment means 29 arranged to provide an indication of the pose of the target relative to the camera viewing the target.

The output 26 is passed to a camera available means 28 that determines, in conjunction with the view means 23, which cameras should be viewing the target. If desired the camera available means 28 is arranged to instruct the view means 23 to examine whether variations in the setting of any camera not presently viewing the target would enable the target to be viewed thereby, and provides an output to alter the camera setting accordingly.

The camera available means 28, outputs 26 and 27, the pose assessment means 29 are coupled to camera selection means 30 having an output for selecting one of the video signals. This includes an algorithm such that if only one camera is viewing the target that camera is normally selected. If more than one camera is available the pose presented to each one is determined and the algorithm selects a camera based upon the presented pose and the outputs 26 and 27.

The presented pose may be assessed by any means known in the art. In this example, the target has associated therewith a vector representing the desired attitude, details thereof being stored in database 22. It is known how to analyse the video signal from the camera in use to determine or assess the relation of that vector to the camera direction. This can be done with a single image, but if the target is moving relative to the camera, analysis of a sequence of images may provide an easier and/or more precise assessment. The relation of the vector to the camera direction is the pose presented to that camera. In this example, only rotation of the target about a vertical axis is considered significant, and this can lead to a simplification is pose assessment. The presented pose could be given, for example, as a function (such as the cosine) of the angle subtended between the vector and the camera direction in the horizontal plane.

The information regarding the vector direction together with the location of the target (output 26) and the map information enable the pose presented to other cameras to be determined or assessed.

The alarm output 21 is also fed to the camera selection means 30, and potentially exercises an over-ride function. Since in this example, only the camera 17 is effective to view the doorway 9, this camera is automatically selected in response thereto regardless of whether or not the originally tracked target lies in its field of view, and an alarm 32 is sounded at the console 31. The remainder of the control means continues to track the original target while this occurs.

The operator responds by viewing the picture from camera 17 on monitor 30, and determining whether to continue viewing a target therein. If not, a spring biassed switch 33 is operated in a first direction and to enable the control means to revert to selecting the original target. If so, the switch 33 is operated in a second direction to turn off the alarm and to enable the operator to define the target, for example by performing in the target detection means the outlining procedure mentioned previously, after which that target is tracked and imaged according to pose in lieu of the original target.

Where there is no operator, or there is no operator response, the system can be arranged to identify a new target in the picture from camera 17, for example by virtue of its movement, and track it.

In a variant of this arrangement, the pose assessment means 29 additionally contains another means for assessing pose based on a further property of the target such as velocity or location. Thus, when the target is moving, or when it moves at a velocity greater than a threshold level, it is assumed that it has a predetermined attitude relative to the velocity vector. Using the location of the target (output 26), the means 29 can then assess the pose relative to the viewing camera, and provide a corresponding output to selection means 30 which over-rides the pose assessed from the target image.

A like method includes attributing a predetermined pose in dependence on location, at least when the target is in predetermined locations and has a velocity within a predetermined range. For example, when the target is a person determined to be located in front of an ATM 13 and is substantially stationary, it is probable that the target is facing the ATM.

The pose determining means 29 may operate an algorithm for assessing the pose based on a number of separate types of determination as exemplified above with corresponding weighting. This algorithm may also operate upon other signals such as outputs 26 and 27 in providing such assessment. Means 29 may be arranged to modify the algorithm based upon feedback provided by an operator when setting up the system so that the most appropriate pose assessment is provided, i.e. a learning system.

In a refinement of the embodiment or the variant(s), means are provided to confirm that the target is not obscured, or excessively obscured, in the image to be selected, for example by is examination of that image, or by using information derived from other cameras or sensors, and for selecting an alternative camera if the degree of obscuration is sufficiently great. The information used to assess obscurement may involve that from previously acquired images of the target and/or its environs, from the camera to be selected and/or from other cameras.

Although the embodiment shows a central control means 20, the reader will realise that the function(s) performed thereby could be effected by a wholly or partially delocalised system, for example one involving processors at some or all of the cameras themselves.

What is claimed is:

1. Target viewing apparatus comprising a plurality of spaced electronic viewing cameras for viewing a predetermined region and for providing respective image signals, the field of view of at least two viewing cameras overlapping in at least a part of said region, identification means for identifying or detecting a target object within said part of said region, and control means responsive to said identifying means for selecting an image signal from a selected one of said at least two cameras, wherein said control means includes means for assessing the pose of the target and selection means arranged for selecting the said one camera at least partly upon the assessed pose.

2. Apparatus according to claim 1 wherein the selection means is arranged for selecting the said one camera to which the target is judged to present a pose nearest to a required pose.

3. Apparatus according to claim 2 wherein the required pose is a predetermined pose.

4. Apparatus according to claim 2 and including means for determining parameters associated with the target and/or other parts of the said part of said region, and for determining the required pose as a function thereof.

5. Apparatus according to claim 4 wherein the step of determining the required pose is made in conjunction with a standard predetermined pose.

6. Apparatus according to claim 4 wherein the determined parameters include at least one of target location, velocity/speed, and target environment.

7. Apparatus according to claim 1 wherein the selection means comprises means for confirming that target is not excessively obscured from the view of the camera to be selected.

8. Apparatus according to claim 1 wherein said assessing means includes means for determining the velocity of the target and for assessing the pose at least in part in dependence thereon.

9. Apparatus according to claim 1 wherein said assessing means includes means for determining the location of the target in relation to a map of the region and for assessing the pose at least in part in dependence thereon.

10. Apparatus according to claim 1 wherein said assessing means includes means for analysing the signal from a said viewing camera viewing the target, or a further camera viewing the target, and for assessing the pose at least in part in dependence thereon.

11. Apparatus according to claim 10 wherein the further camera is arranged for viewing substantially all of the predetermined region.

12. Apparatus according to claim 10 wherein said assessing means includes means for measuring a visible characteristic of the target and for assessing the pose at least in part in dependence thereon.

13. Apparatus according to claim 12 wherein said visible characteristic is a flesh-tone area, said assessing means includes means for measuring the area and for assessing the pose at least in part in dependence thereon.

14. Apparatus according to claim 10 wherein the target is specified to have a predetermined general three dimensional shape, said assessing means includes means for detecting a two dimensional image shape derived therefrom and for assessing the pose at least in dependence thereon.

15. Apparatus according to claim 14 wherein the target has a specified rigid shape.

16. Apparatus according to claim 14 wherein the target has a specified flexible shape and the assessing means includes means for modelling the flexible shape and matching a two dimensional image shape thereto, whereby to assess the pose.

17. Apparatus according to claim 1 wherein the assessing means is arranged so that the manner of assessing pose can change over time.

18. Apparatus according to claim 1 including means for controlling the plurality of cameras to track the target as it moves between the fields of view of different cameras.

19. Apparatus according to claim 18 arranged such that not all the of the plurality of cameras are simultaneously active, but wherein at least one of said at least two cameras is activated in the presence of said target in the said part of said region.

20. Apparatus according to claim 19 wherein at least said two cameras are activated in the presence of said target in the said part of said region.

21. Apparatus according to claim 20 wherein selection of said one camera is by selection of its image signal.

22. Apparatus according to claim 1 wherein selection of said one camera is effected by selective activation thereof.

23. Apparatus according to claim 1 wherein the presence of the target is initially identified from at least one said image signal by detection of movement.

24. Apparatus according to claim 1 wherein the presence of the target is initially identified from at least one said image signal by detection of a predetermined colour, hue, texture and/or shape.

25. Apparatus according to claim 1 wherein the presence of a target is detected by an alarm sensor associated with said part of said region.

26. Apparatus according to claim 1 wherein the control means is arranged to alter the mode of identifying the target after an initial identification thereof.

27. Apparatus according to claim 1 wherein said selected camera is a video camera capable of continuous production of a said image signal.

28. Apparatus according to claim 1 wherein said selected camera is a digital photographic camera capable of providing image signals at discrete intervals.

29. Apparatus according to claim 1 and including means for displaying and/or recording the image signal from said selected camera.

30. A method of controlling a plurality of spaced electronic viewing cameras each viewing the same target object, the method comprising the steps of assessing the pose of the target and selecting an output image signal from one of said viewing cameras at least partly on the basis of the assessed pose.

31. A method according to claim 30 wherein the selecting step is such that the selected camera is that to which the target is judged to present a pose nearest to a required pose.

32. A method according to claim 31 wherein the required pose is a predetermined pose.

33. A method according to claim 31 wherein parameters associated with the target are determined, and the required pose is determined as a function thereof, optionally in conjunction with a standard pose.

34. A method according to claim 33 wherein the determined parameters include at least one of target location, velocity/speed, and target environment.

35. A method according to claim 30 and including the step of confirming that target is not excessively obscured from the view of the camera to be selected.

36. A method according to claim 30 wherein the assessing step includes determining the velocity of the target and assessing the pose at least in part in dependence thereon.

37. A method according to claim 30 wherein the assessing step includes determining the location of the target in relation to a map of the region and assessing the pose at least in part in dependence thereon.

38. A method according to claim 30 wherein the assessing step includes measuring an intrinsic characteristic of the target and assessing the pose at least in part in dependence thereon.

39. A method according to claim 38 wherein the intrinsic characteristic is measured by an analysis of an image signal.

40. A method according to claim 39 wherein said intrinsic characteristic is a flesh-tone area, and said assessing step means includes measuring the area and assessing the pose at least in part in dependence thereon.

41. A method according to claim 38 wherein the target is specified to have a predetermined general three dimensional shape, and said assessing step includes detecting a two dimensional image shape derived from the three dimensional shape and assessing the pose at least in part in dependence thereon.

42. A method according to claim 41 wherein the target has a specified rigid shape.

43. A method according to claim 41 wherein the target has a specified flexible shape and the assessing step includes modelling the flexible shape and matching a two dimensional image shape thereto, whereby to assess the pose.

44. A method according to claim 30 including the step of controlling the plurality of cameras to track the target as it moves between the fields of view of different cameras.

45. A method according to claim 44 wherein the controlling step is such that not all the of the plurality of cameras are simultaneously active, but wherein at least one of said at least two cameras are activated when said target is present in said overlapped fields.

46. A method according to claim 45 wherein at least said two cameras are activated when said target is present in said overlapped fields.

47. A method according to claim 30 wherein said selecting step comprises selection of the image signal of said one camera.

48. A method according to claim 30 wherein said selecting step includes activation of said one camera.

49. A method according to claim 30 and including the step of initially identifying the presence of the target from at least one said image signal by detection of movement.

50. A method according to claim 30 and including the step of initially identifying the presence of the target from at least one said image signal by detection of a predetermined colour, hue, texture and/or shape.

51. A method according to claim 30 and including the step of initially identifying the presence of the target by an alarm sensor associated with said part of said region.

52. A method according to claim 30 wherein information concerning said target is collected and analysed over a period of time to enable subsequent identification thereof.

53. A method according to claim 30 and including the step of displaying and/or recording the image signal from said selected camera.
